(19) United States
(12) Patent Application Publication
(10) Pub. No.: US 2011/0007823 A1
(43) Pub. Date: Jan. 13, 2011

(54) IMAGE PROCESSING DEVICE AND IMAGING DEVICE EQUIPPED WITH SAME

(76) Inventors: Yoshihiro Matsuo, Gifu (JP); Shigeyuki Okada, Gifu (JP)

Correspondence Address: MCDERMOTT WILL & EMERY LLP, 600 13TH STREET, N.W., WASHINGTON, DC, 20005-3096, US

(21) Appl. No.: 12/922,596

(22) PCT Filed: Mar. 5, 2009
(86) PCT No.: PCT/JP2009/001008

§ 371 Date: Sep. 14, 2010

(30) Foreign Application Priority Data
Mar. 14, 2008 (JP) 2008-065824
Sep. 2, 2008 (JP) 2008-225348

(51) Int. Cl. H04N 7/26

(52) U.S. Cl. 375/240.26; 375/E07.089

(57) ABSTRACT

A decoding unit decodes an encoded stream in which moving images are encoded. A display unit displays the moving images decoded by the decoding unit. An acquisition unit acquires tracking information indicating identification information, which is added within the encoded stream, that indicates whether a specific object is detected within a frame image included in the moving images. In reference to detection information acquired by the acquisition unit, a control unit skips or fast-forwards at least one frame image for which tracking of the specific object has failed.

### TECHNICAL FIELD

The present invention relates to an image processing apparatus for processing moving images and to an image pickup apparatus provided with the image processing apparatus.

### BACKGROUND ART

Digital movie cameras by which general users can easily capture moving images have become widely used. With the widespread use of digital movie cameras, players available for playing back moving images captured by such digital movie cameras have also become widely used.

A general user often captures the image of a specific object by using a digital movie camera while tracking the object so that it continues to stay within the screen. A typical example of this is a situation when a parent captures the image of his/her child, who is running during a sporting event.

Patent document No. 1 discloses an object tracking device, and the object tracking device tracks an object by extracting a feature quantity in accordance with a slight difference and change of color.
[Patent document No. 1] JP 7-95597

### DISCLOSURE OF THE INVENTION

### Problem to be Solved by the Invention

Using a player, a general user can view moving images captured by a digital movie camera. When viewing moving images captured while targeting a specific object as an object of interest, it is obvious that the main purpose is to view the object.

However, there are occasions during image capturing, while tracking a specific object, when the object cannot be tracked, meaning that the object goes outside of the screen. A scene in which the image of the object is not captured is considered to have a lower viewing priority than that of a scene in which the image of the object is captured. Some users fast-forward the scene in which the image of the object is not captured by pressing a fast-forward button. The same applies to viewing moving images captured by others if the main purpose is to view a specific object.

In this background, a purpose of the present invention is to provide an image processing apparatus that allows for preferentially viewing a specific object or supporting the viewing without performing a specific operation and to an image pickup apparatus provided with the image processing apparatus.

### Means for Solving the Problem

An image processing apparatus according to one embodiment of the present invention reproduces, during the reproduction of moving images, a frame image that includes a specific object in a normal manner and skips or reproduces, in a fast-forward manner, at least one frame image not including the specific object.

Still another embodiment of the present invention also relates to an image processing apparatus. The apparatus comprises: a coding unit configured to generate an encoded stream by encoding moving images; an object detection unit configured to detect a specific object from within a frame image included in the moving images; and an object tracking unit configured to track the specific object detected by the object detection unit and to generate tracking information based on the status of the tracking. The coding unit adds the tracking information generated by the object tracking unit into the encoded stream.

Optional combinations of the aforementioned constituting elements and implementations of the invention in the form of methods, apparatuses, systems, recording mediums, and computer programs may also be practiced as additional modes of the present invention.

### Advantageous Effects

The present invention allows for preferentially viewing a specific object or supporting the viewing without performing a specific operation.

### BRIEF DESCRIPTION OF THE DRAWINGS

FIG. 1 illustrates a structure of an image pickup apparatus according to a first embodiment;

FIG. 2 is a diagram explaining an operation example of an image processing apparatus according to the first embodiment;

FIG. 3 illustrates a structure of an image processing apparatus according to a second embodiment; and

FIG. 4 is a diagram explaining an operation example of the image processing apparatus according to the second embodiment.

### EXPLANATION OF REFERENCE NUMERALS

10 coding unit

12 object detection unit

14 object tracking unit

16 object registration unit

20 decoding unit

22 display unit

24 acquisition unit

26 control unit

28 operation unit

50 image pickup unit

100 image processing apparatus

200 image processing apparatus

500 image pickup apparatus

### BEST MODE FOR CARRYING OUT THE INVENTION

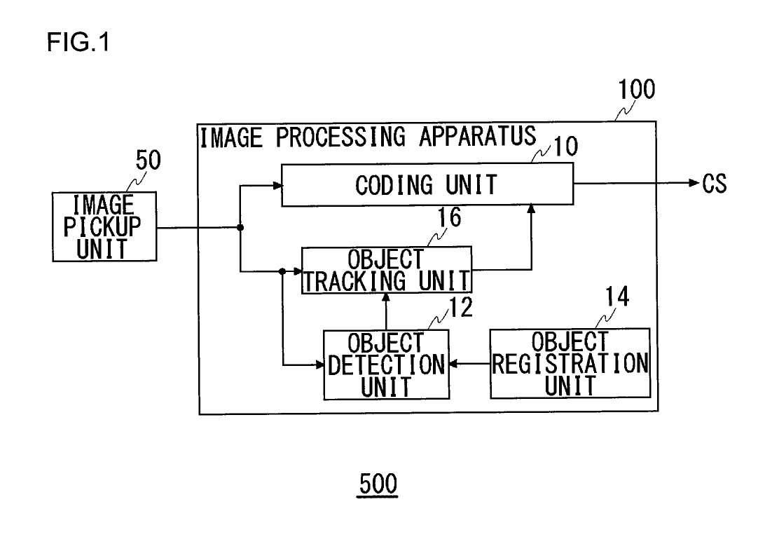

FIG. 1 illustrates the structure of an image pickup apparatus 500 according to a first embodiment. The image pickup apparatus 500 according to the first embodiment is provided with an image pickup unit 50 and an image processing apparatus 100.

The image pickup unit 50 acquires moving images and provides the moving images to the image processing apparatus 100. The image pickup unit 50 is provided with solid-state image pickup devices (not shown), such as CCD (Charge-Coupled Device) sensors and CMOS (Complementary Metal-Oxide Semiconductor) image sensors, and a signal processing circuit (not shown) for processing a signal output by the solid-state image pickup devices. The signal processing circuit allows for the conversion of the analog signals of the three primary colors R, G, and B, which are output by the solid-state image pickup devices, into a digital luminance signal Y and color-difference signals Cr and Cb.

The image processing apparatus 100 processes moving images acquired by the image pickup unit 50. The image processing apparatus 100 includes a coding unit 10, an object detection unit 12, an object registration unit 14, and an object tracking unit 16. The configuration of the image processing apparatus 100 is implemented in hardware by any CPU of a computer, memory, or other LSI's, and in software by a program or the like loaded into the memory. Functional blocks implemented by the cooperation of hardware and software are depicted. Thus, a person skilled in the art should appreciate that there are many ways of accomplishing these functional blocks in various forms in accordance with the components of hardware only, software only, or the combination of both.

The coding unit 10 generates an encoded stream by encoding moving images acquired by the image pickup unit 50. More specifically, the coding unit 10 generates an encoded stream by compressing and encoding the moving images in accordance with predetermined standards. For example, moving images are compressed and encoded in accordance with the H.264/AVC, MPEG-2, or MPED-4 standard.

The object detection unit 12 detects a specific object from a frame image included in moving images acquired by the image pickup unit 50. The object registration unit 14 registers the specific object in the object detection unit 12. For example, the face of a child can be captured by using the image pickup unit 50 and then registered. Examples of the object include a person, a pet such as a dog or cat, or a moving object such as a car or train. A description is given hereinafter while using an example of when the object is a person.

A person to be designated as an object may be the one detected first in the frame image after the image capturing of the moving images is started or may be a specific person registered by the object registration unit 14. In the former case, dictionary data for detecting every person is used, and in the latter case, dictionary data for detecting a specific registered person is used. The first detected person or the specific registered person is designated to be a tracking target in a subsequent frame image.

The object detection unit 12 allows for the identification of a person by detecting the face in the frame image. The object detection unit 12 sets a body region below a face region that includes the detected face. The size of the body region is designed to be proportionate to the size of the face region. A person region including the whole body of the person may be set for the tracking target.

A face detection process may be performed with use of a publicly-known method. The method is not limited to a particular method. For example, a face detection method through an edge detection method, a boosting method, a hue extraction method, or a skin-color extraction method can be used.

In the edge detection method, various edge features are extracted from the face region including the eyes, the nose, the mouth, and the contour of a face in a face image where the size of the face or the gray value is normalized in advance, and a feature quantity effective for identifying whether or not an object is a face is learned based on a statistical technique, thereby constructing a face discriminator. Regarding the face of a specific person registered by the object registration unit 14, a face discriminator is constructed by using a face image thereof.

To detect a face from within the input image, a similar feature quantity is extracted while performing raster scanning on an input image by using a face size normalized at the time of learning, starting from an edge of the input image. Based on the feature quantity, the face discriminator determines whether or not the region is for a face. For example, a horizontal edge, a vertical edge, a diagonal right edge, and a diagonal left edge can be used for the feature quantity. When a face is not detected, the input image is reduced by a constant ratio, and a face search is conducted by raster-scanning the reduced image in a similar manner as described above. Repeating this process allows for a face of an arbitrary size to be detected from the image.

The object tracking unit 16 tracks the specific object detected by the object detection unit 12 and generates tracking information based on the status of the tracking. The generated tracking information is provided to the coding unit 10. The coding unit 10 adds the tracking information generated by the object tracking unit 16 into the encoded stream.

The object tracking unit 16 can track the specific object, which is detected by the object detection unit 12, in a subsequent frame and tell whether the tracking was successful or had failed in each frame image. In this case, the coding unit 10 adds, as the tracking information, information indicating whether the tracking was successful or had failed to a header region or region in which a user is allowed to write (hereinafter, referred to as a user region) of each frame image. The information indicating whether the tracking was successful or had failed for each frame image may be described together in a sequence header region or a GOP (Group of Pictures) header region instead of a picture header region.

The object tracking unit 16 can track a specific object based on color information of the object. In the above-described example, tracking is carried out by searching, in a subsequent frame image, for a region of a color similar to that of the body region. Taking into account the results of face detection by the object detection unit 12 in the subsequent frame image allows for the tracking accuracy to be improved.

Whether the tracking is successful or not is determined as follows: The object tracking unit 16 determines that tracking is successful for a frame image if an object to be tracked is included within the frame image and that the tracking has failed if the object to be tracked is not included within the frame image. A unit of tracking the object may be a unit of the face region or a unit of the person region.

The object tracking unit 16 can generate whether tracking is successful or not for each frame image as a flag as the tracking information. In this case, the coding unit 10 describes a corresponding flag in a header area and a user area of each frame image.

The object tracking unit 16 can specify a frame image in which a specific object is no longer within the screen. In that case, the coding unit 10 adds information, which indicates that the specific object is no longer within the screen, as the tracking information to the header area or the user area of the frame image specified by the object tracking unit 16. The object tracking unit 16 can specify a frame image in which the specific object is back within the screen. In that case, the coding unit 10 adds information, which indicates that the specific object is back within the screen, as tracking information to the header area or the user area of the frame image specified by the object tracking unit 16.

The coding unit 10 generates an encoded stream CS to which the tracking information is added and records the encoded stream CS in a recording medium (not shown) such as a memory card, a hard disk, or an optical disk or transmits the encoded stream CS to a network.

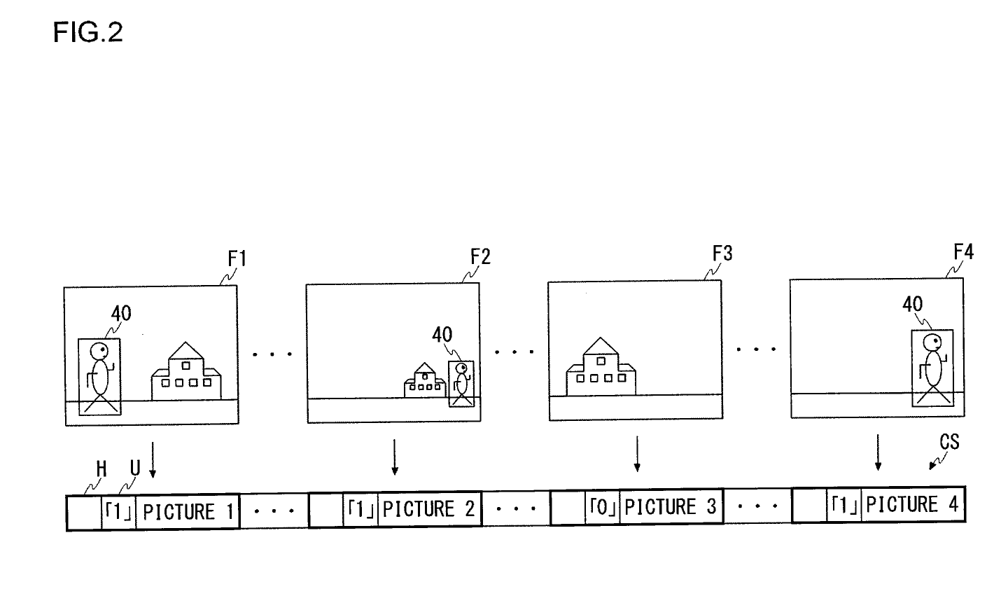

FIG. 2 is a diagram explaining an operation example of an image processing apparatus 100 according to the first embodiment. Predetermined moving images include a first frame image F1, a second frame image F2, a third frame image F3, and a fourth frame image F4, in increasing order of time elapsed. The moving images are captured while targeting a specific person as an object of interest.

The object detection unit 12 detects a specific person from within the first frame image F1 as an object and sets a person region 40, which includes the entire body of the person. The object tracking unit 16 tracks the person region 40 within subsequent frame images. The coding unit 10 generates an encoded stream CS by encoding each frame image. A flag indicating whether the tracking is successful or not is added to a header area H or a user area U of each picture. The flag is added to the user area U in this case. The flag indicates that the tracking is successful by using “1” or that the tracking has failed by using “0”.

In FIG. 2, 1's are added to respective user areas U of a picture 1 into which the first frame image F1 is encoded, a picture 2 into which the second frame image F2 is encoded, and a picture 4 into which the fourth frame image F4 is encoded, and 0 is added to the user area U of a picture 3 into which the third frame image F3 is encoded. This is because the specific person is not captured in the third frame image F3.

As described above, the first embodiment allows for support to preferentially view a specific object, without performing a specific operation on the reproduction side, by adding tracking information into an encoded stream. Adding tracking information, which indicates the change of the status of the specific object, as tracking information only to a frame image in which the specific object is detected first, to a frame image in which the specific object is no longer within the screen, and to a frame image in which the specific object is back within the screen allows for the reduction in the amount of coding necessary for the addition of the tracking information. For the reproduction side, it is only necessary to be aware that whether the tracking is successful or not, which is indicated in the latest frame image with the tracking information added, is also valid for a frame image without the tracking information added.

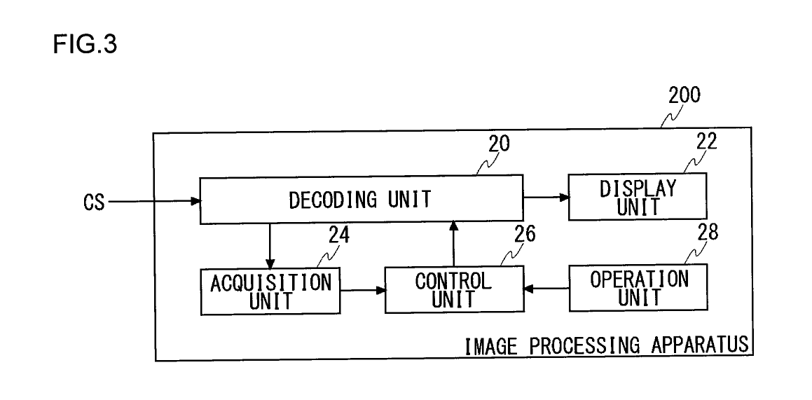

FIG. 3 illustrates a structure of an image processing apparatus 200 according to a second embodiment. The image processing apparatus 200 according to the second embodiment may be provided as a function of an image pickup apparatus 500 or may be configured as a single device. The image processing apparatus 200 is provided with a function of reproducing moving images and reproduces, during the reproduction of moving images, a frame image that includes a specific object in a normal manner and skips or reproduces, in a fast-forward manner, at least one frame image not including the specific object. Reproduction in a normal manner means a reproduction method of normal reproduction speed.

In general, when a specific object being tracked goes outside of the screen, there will be a plurality of passing frame images until the specific object comes back into the screen. Therefore, an interval is generated where successive frame images exist that do not include the specific object, and moving images that are reproduced during the interval can become subject to fast-forwarding. Frame images to be skipped or fast-forwarded may be all or a part of the frame images that do not include the specific object. For example, even frame images that do not include the specific object may be reproduced in a normal manner during at least either the beginning or the ending of the interval where there are the successive frame images. The frame images may be fast-forwarded during the beginning or the ending and may be skipped during the period between the two. In these cases, a user can be fully aware of a change of an interval into the interval where successive frame images exist that do not include a specific object.

A detailed description is now given in the following. The image processing apparatus 200 is provided with a decoding unit 20, a display unit 22, an acquisition unit 24, a control unit 26, and an operation unit 28.

The decoding unit 20 decodes an encoded stream CS in which moving images are encoded. The encoded stream CS may be generated by the image processing apparatus 100 according to the first embodiment. The display unit 22 displays moving images decoded by the decoding unit 20.

The acquisition unit 24 acquires identification information, which is added within the encoded stream CS, that indicates whether a specific object is detected within a frame image included in moving images. The identification information may be the above-stated tracking information.

In reference to the identification information acquired by the acquisition unit 24, the control unit 26 skips or fast-forwards at least one frame image for which the tracking of the specific object has failed. When skipping a frame image, the control unit 26 takes control so as to discard the frame image to be skipped, which is within a buffer (not shown) where a frame image decoded by the decoding unit 20 is temporarily stored. When fast-forwarding a frame image, the control unit 26 takes control so as to speed up the time at which the frame image to be fast-forwarded is output from the buffer to the display unit 22.

Upon the receipt of a user's instruction, the operation unit 28 transmits the instruction to the control unit 26. In the embodiment, the selection of a reproduction method of moving images including a specific object is received. The reproduction method can be selected among three modes shown as follows:
(1) a normal mode for reproducing all frame images in a normal manner;
(2) a skip mode for skipping a frame image in which the image of a specific object is not captured; and
(3) a fast-forward mode for fast-forwarding through an interval in which there are successive frame images in which the image of the specific object is not captured. When the normal mode is selected via the operation unit 28, the control unit 26 reproduces a frame image, for which the tracking of the specific object has failed, in a similar way as a frame image for which the tracking is successful. When the skip mode is selected via the operation unit 28, the control unit 26 skips a frame image for which the tracking of the specific object has failed. When the fast-forward mode is selected via the operation unit 28, the control unit 26 fast-forwards a frame image for which the tracking of the specific object has failed.

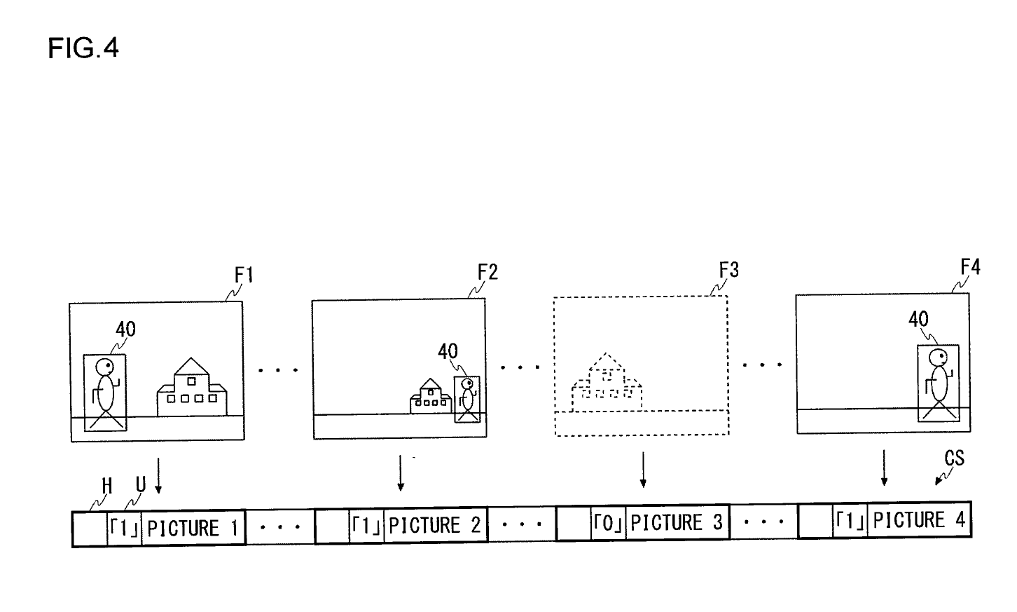

FIG. 4 is a diagram explaining an operation example of an image processing apparatus 200 according to the second embodiment. Moving images shown in FIG. 4 are captured by the image processing apparatus 100 according to the first embodiment shown in FIG. 2.

The acquisition unit 24 acquires a flag indicating whether tracking is successful or not from a user area U of each picture of the encoded stream CS. In reference to the flag, the control unit 26 determines whether to reproduce, in a normal manner, a frame image in which each picture is decoded or to skip (or it may reproduce the frame image in a fast-forward manner instead of skipping it) the frame image.

In FIG. 4, a first frame image F1 in which a picture 1 is decoded, a second frame image F2 in which a picture 2 is decoded, and a fourth frame image F4 in which a picture 4 is decoded, all to which “1” is added as a flag, are reproduced in a normal manner. A third frame image F3 in which a picture 3 is decoded, to which “0” is added as a flag, is skipped.

As described above, the second embodiment allows for preferentially viewing a specific object, without performing a specific operation, by using tracking information added into an encoded stream. In other words, an image within an interval in which the image of a specific object is not captured can be automatically skipped or fast-forwarded without a user's pressing of a fast-forward button. Allowing for a reproduction method of an image within the interval to be selected among normal reproduction, skipping, and fast-forwarding, a variety of user's preferences can be satisfied.

Described above is an explanation based on the embodiments of the present invention. These embodiments are intended to be illustrative only, and it will be obvious to those skilled in the art that various modifications to constituting elements and processes could be developed and that such modifications are also within the scope of the present invention.

As a first exemplary variation, the object detection unit 12 may identify the size of a specific object and determine the degree of properness of a super-resolution process performed on a region that includes the specific object. The super-resolution process is a technique of generating, from a plurality of images with a slight shift in respective positions, an image having a resolution higher than that of the plurality of images. A details of the super-resolution process is disclosed, for example, in: Aoki, Shin, “Super Resolution Processing by Plural Number of Lower Resolution Images,” Ricoh Technical Report No. 24, NOVEMBER, 1998; JP 2005-197910; JP 2007-205; and JP 2007-193508.

When a device on the reproduction side is provided with a function for performing a super-resolution process on a region that includes a specific object by using a plurality of frame images included in moving images, the device can use the function to enlarge and display the specific object. When the size of the specific object is too small, it is difficult to restore a high frequency-component even with use of a plurality of frame images having a slight shift in the respective positions. Thus, an effect of the super-resolution process cannot be obtained. Rather, an image having much noise may be generated. A designer can obtain the size at which the effect of the super-resolution process can no longer be obtained, through experiment or simulation, and set the size to be a threshold value.

The object detection unit 12 determines that the super-resolution process is not proper when the size of the specific object is at or below the threshold value and determines that the super-resolution process is proper when the size exceeds the threshold value. The object tracking unit 16 can include information indicating whether or not the super-resolution process is proper in the tracking information to be added to the header area and the user area of each frame image. For example, a flag may be generated that indicates that the super-resolution process is proper by using “1” and that the process is not proper by using “0”.

The acquisition unit 24 can acquire the information indicating whether or not the super-resolution process is proper, and the control unit 26 can thus determine whether or not the region is appropriate for the super-resolution process. For example, when an instruction is given to enlarge a region that has determined not to be proper for the super-resolution process, the region is treated as not being able to be enlarged or is enlarged by a spatial pixel-interpolation process. As the pixel-interpolation process, a simple linear interpolation process or an interpolation process with use of a FIR filter can be employed.

In the first embodiment, an encoded stream is generated by also encoding a frame image, for which the tracking of the specific object has failed, in a similar way as a frame image for which the tracking is successful. As a second exemplary variation, a frame image, for which the tracking of the specific object has failed, may be excluded so as to generate an encoded stream. In other words, the coding unit 10 generates the encoded stream while excluding at least one frame image, for which the tracking has failed, that has been specified by the object tracking unit 16. The excluded frame image may be generated as another file or discarded. Since no process is required on the reproduction side, this allows for skipping a frame image in which the image of a specific object is not captured.

In the first embodiment, the coding unit 10 adds the tracking information into the encoded stream. As a third exemplary variation, the tracking information may be recorded in a file different from that of the encoded stream. In this case, the tracking information can be acquired without decoding the encoded stream on the reproduction side.

In the second exemplary variation, a frame image, for which the tracking has failed, is excluded so as to generate an encoded stream. As a fourth exemplary variation, an encoded stream may be generated for a frame image in which a specific object is no longer within the screen or for a frame image in which the specific object is back within the screen so that a user can have easy access. In compression encoding in accordance with the H.264/AVC, MPEG-2, or MPED-4 standard, a process such as orthogonal transformation or quantization is performed on a prediction error, which is the difference between a predicted reference image and an image to be encoded. Intra-frame prediction encoding where a reference image is predicted in an image within a frame to be encoded provides better accessibility during decoding than inter-frame prediction encoding where a reference image is predicted by also using other images of frames other than the frame to be encoded. This is because it is necessary to decode frame images including the frame image to be decoded and other frame images that include a reference image thereof in order to decode a frame image on which inter-frame prediction encoding has been performed. Thus, the coding unit 10 generates an encoded stream by performing intra-frame prediction encoding on a frame image in which a specific object is no longer within the screen or a frame image in which the specific object is back within the screen. Intra-frame prediction encoding may be performed on both the frame image in which the specific object is no longer within the screen and the frame image in which the specific object is back within the screen or on at least one of the frame images. This allows for efficient search of these frame images, thus achieving encoding in accordance with user's preferences.

In the second exemplary variation, a frame image, for which the tracking has failed, is excluded so as to generate an encoded stream. As a fifth exemplary variation, an encoded stream may be generated, with high compressibility, for frame images starting from the frame image in which the specific object is no longer within the screen to the frame image in which the specific object is back within the screen, in other words, during a period when the tracking of the specific object fails. This is because it is more efficient to increase compressibility and suppress the encoding amount since a scene during a period when the tracking of the specific object is unsuccessful has a lower viewing priority compared to a scene during a period when the tracking of the specific object is successful. The coding unit 10 generates an encoded stream with high compressibility by, for example, setting a quantization step size to be large during a period when the tracking of the specific object is unsuccessful. The compressibility needs to be set so that the encoding amount is suppressed during the period when the tracking of the specific object is unsuccessful. For example, the compressibility may be set, for a frame image on which intra-frame prediction encoding is performed, to be higher than the compressibility during the period when the tracking of the specific object is successful and may be set, for a frame image on which inter-frame prediction encoding is performed, to be at the same level or lower than the compressibility during the period when the tracking of the specific object is successful. This allows for the generation of an encoded stream in which an encoding amount is suppressed during a period when the tracking of the specific object is unsuccessful, thus achieving encoding in accordance with user's preferences. Also, the capacity of an entire encoded stream can be reduced.

In the second exemplary variation, a frame image, for which the tracking has failed, is excluded so as to generate an encoded stream. As a sixth exemplary variation, an encoded stream may be generated while reducing the resolution during a period when the tracking of the specific object is unsuccessful. This is because it is more efficient to reduce resolution and suppress the encoding amount since a scene during a period when the tracking of the specific object is unsuccessful has a lower viewing priority compared to a scene during a period when the tracking of the specific object is successful. The coding unit 10 generates low-resolution frame images in which pixels are thinned out at a predetermined interval during a period when the tracking of the specific object is unsuccessful and then generates an encoded stream from the low-resolution frames. The thinning-out process may be performed, for example, after performing a smoothing process on the frame images by using an FIR filter so as to reduce artificiality due to the thinning-out of the pixels. The resolution needs to be set so that the encoding amount is suppressed during the period when the tracking of the specific object is unsuccessful. For example, the resolution may be set, for a frame image on which intra-frame prediction encoding is performed, to be lower than the resolution during the period when the tracking of the specific object is successful and may be set, for a frame image on which inter-frame prediction encoding is performed, to be at the same level or higher than the resolution during the period when the tracking of the specific object is successful. This allows for the generation of an encoded stream in which an encoding amount is suppressed during a period when the tracking of the specific object is unsuccessful, thus achieving encoding in accordance with user's preferences. Also, the capacity of an entire encoded stream can be reduced.

### INDUSTRIAL APPLICABILITY

The present invention can be applied in a field where moving images are processed.

1-2. (canceled)

3. An image processing apparatus comprising:
a coding unit configured to generate an encoded stream by encoding moving images;
an object detection unit configured to detect a specific object from within a frame image included in the moving images; and
an object tracking unit configured to track the specific object detected by the object detection unit and to generate tracking information based on the status of the tracking, wherein
the coding unit adds the tracking information generated by the object tracking unit into the encoded stream.

4. The image processing apparatus according to claim 3, wherein
the object tracking unit tracks the specific object, which is detected by the object detection unit, in a subsequent frame and specifies whether the tracking is successful or has failed in each frame image, and
the coding unit adds, as the tracking information, information indicating whether the tracking is successful or has failed to a header area or an area, in which a user is allowed to write, of each frame image.

5. The image processing apparatus according to claim 3, wherein
the object tracking unit specifies a frame image in which the specific object is no longer within a screen,
the coding unit adds information, which indicates that the specific object is no longer within the screen, as the tracking information to a header area or area, in which a user is allowed to write, of a frame image specified by the object tracking unit;
the object tracking unit specifies a frame image in which the specific object is back within a screen, and
the coding unit adds information, which indicates that the specific object is back within the screen, as the tracking information to a header area or area, in which a user is allowed to write, of a frame image specified by the object tracking unit.

6. An image processing apparatus comprising:
a coding unit configured to generate an encoded stream by encoding moving images;
an object detection unit configured to detect a specific object from within a frame image included in the moving images; and
an object tracking unit configured to track the specific object detected by the object detection unit, wherein
the coding unit generates the encoded stream while excluding at least one frame image, for which tracking has failed, that is specified by the object tracking unit.

7. An image processing apparatus comprising:
a coding unit configured to generate an encoded stream by encoding moving images;
an object detection unit configured to detect a specific object from within a frame image included in the moving images; and
an object tracking unit configured to track the specific object detected by the object detection unit, wherein
the coding unit generates the encoded stream by performing intra-frame prediction encoding on at least one frame image among a frame image, in which the specific object is no longer within a screen, and a frame image, in which the specific object is back within the screen, that are specified by the object tracking unit.

8. An image processing apparatus comprising:
a coding unit configured to generate an encoded stream by encoding moving images;
an object detection unit configured to detect a specific object from within a frame image included in the moving images; and
an object tracking unit configured to track the specific object detected by the object detection unit, wherein
the coding unit generates the encoded stream by encoding, at a compressibility different from that of a frame image for which tracking has been successful, at least one frame image, for which tracking has failed, that is specified by the object tracking unit.

9. An image processing apparatus comprising:
a coding unit configured to generate an encoded stream by encoding moving images;
an object detection unit configured to detect a specific object from within a frame image included in the moving images; and
an object tracking unit configured to track the specific object detected by the object detection unit, wherein
the coding unit generates the encoded stream by encoding, at a resolution different from that of a frame image for which tracking has been successful, at least one frame image, for which tracking has failed, that is specified by the object tracking unit.

10. (canceled)
